(19) United States
(12) Patent Application Publication
(10) Pub. No.: US 2002/0111197 A1
(43) Pub. Date: Aug. 15, 2002

(54) Cordless telephone headset system

(76) Inventor: Robert M. Fitzgerald, Denver, CO (US)

Correspondence Address: IP PATENTS, FAEGRE & BENSON LLP, 1900 FIFTEENTH STREET, BOULDER, CO, 80302, US

(21) Appl. No.: 10/038,939

(22) Filed: Jan. 4, 2002

Related U.S. Application Data
(60) Provisional application No. 60/259,879, filed on Jan. 4, 2001.

(51) Int. Cl. H04M 1/00

(52) U.S. Cl. 455/568; 455/569; 455/462; 455/74.1

(57) ABSTRACT

The present invention provides a cordless telephone headset system having a cordless telephone headset and a base. Adjustment of the cordless telephone headset may be accomplished through the provision of a telephone control, and in preferred embodiments a dial pad, pivotally connected to a headband of the headset. The telephone control is configured to accommodate a plurality of user configurations and is adjustably connected to the headband to provide a range of adjustable rotation. Adjustment of the cordless telephone headset may also be accomplished, and in some embodiments in combination with the adjustment of the telephone control, through the provision of a microphone, and in preferred embodiments further providing a microphone boom, pivotally connected to the telephone control. The microphone and microphone boom are configured to accommodate a plurality of user configurations and are adjustably connected to the telephone control to provide a range of adjustable rotation. Methods of configuring a cordless telephone headset system for use are also disclosed.

The present application claims the benefit of U.S. provisional application 60/259,879, filed Jan. 4, 2001, and further claims priority to U.S. design application 29/133,434, filed Nov. 30, 2000, each hereby incorporated by reference.

### BACKGROUND OF THE INVENTION

1. Field of the Invention

This invention relates generally to cordless headset telephones, and more particularly to an ultralight headset telephone which includes features designed to enhance its ergonomics and comfort while providing broad telephone functionality.

2. Description of the Related Art

The basic cordless telephone headset is known. One such headset is shown, for example, in U.S. Pat. No. 5,113,428, issued May 12, 1992, of Robert Fitzgerald (the inventor of the instant application) for a Cordless Telephone Headset. That headset is binaural. Other monaural headsets have a speaker in only one earpiece. For example, U.S. patent application Ser. No. 29/133,434 of Robert Fitzgerald shows the ornamental design of a monaural cordless telephone headset, which design is now being used to house a functional embodiment of the present invention. Likewise, U.S. patent application Ser. No. 29/133,500 (now U.S. Pat. No. D445,772, issued Jul. 31, 2001) of Robert Fitzgerald shows the ornamental design of a base unit, which design is now being used to house a functional embodiment of the present invention.

Despite the advances in cordless telephone headsets, there remain obstacles to their acceptance by consumers. A cordless telephone headset which has broad telephone functionality, and which combines an ultra-lightweight, pleasing design with significant user-friendly ergonomic and functional features, such as a swivel dialpad and ratcheting swivel microphone boom arm in the headset; an upright orientation of the headset in the base; a mute switch in the boom; a secured battery door; and the ability to connect to a personal computer for enabling telephone conversation over a networked computer via a global communications network would all be desirable in a cordless telephone headset.

Further efforts to address some of the past inadequacies of cordless telephone headsets, some of which are identified above, have been made in an attempt to provide adequate functionality and other desirable features to cordless telephone technology. The previous effort provided in the HELLO DIRECT Cordless XLT cordless phone provides a cordless headset for ease of use, but may fail to adequately address the need for phone functionality and control at the headset. Furthermore, the HELLO DIRECT Cordless XLT cordless phone may not sufficiently provide for adequate ergonomic and adjustment features addressed by the present invention. Other attempts have been made to provide adequate adjustment, such as the GN NETCOM Stratus Ultra-G (TM) Corded Headset. However, such efforts appear to sacrifice phone functionality at the headset and may further lack adequate adjustment features for more capable cordless telephone headsets, as addressed by the present invention.

### SUMMARY OF THE INVENTION

This invention is directed to a cordless telephone headset and systems thereof. It is a related object of the present invention to provide a comfortable, ultra-lightweight, in some embodiments under 7 ounces with batteries, wireless telephone headset, operating in conjunction with a base unit. It is a specific object of the present invention to provide a cordless telephone headset and system that provides the ability to use the headset remotely from the base. It is a further object of the present invention to provide a cordless telephone headset that provides circuitry with clarity and other functionality comparable to that of a corded phone. It is a related object to provide a lightweight headset feature that allows freedom of movement for hands-free convenience while a user is on the phone, with sufficient comfort that the user will enjoy the experience.

Embodiments of the invention provide features such as a telephone control pivotally connected to a head band, and particularly a swivel dial pad, a microphone pivotally connected to the telephone control, and particularly a swivel microphone boom in the headset; an upright orientation of the headset within the base; a secured battery door; a rotary volume control; a mute switch in the microphone boom; and the ability to connect to a computer for phone conversations conducted via a networked computer. Additional objects, advantages, and novel features of the invention are set forth in part in the description that follows and will become apparent to those skilled in the art upon examination and understanding of the following description and figures or may be learned by the practice of the invention. Further, the objects and the advantages of the invention may be realized and attained by means of the instrumentalities and in combinations particularly pointed out in the appended claims.

### BRIEF DESCRIPTION OF THE DRAWINGS

The accompanying drawings, which are incorporated in and form a part of the specification, illustrate the preferred embodiments of the present invention, and together with the descriptions serve to explain the principles and enabling of the invention.

FIG. 1 is a right side front perspective view of a cordless telephone headset according to this invention;

FIG. 2 is a right side rear view of the headset of FIG. 1;

FIG. 3 is a right side elevation view of the headset of FIG. 1;

FIG. 4 is a left side elevation view of the headset of FIG. 1;

FIG. 5 is a back elevation view of the headset of FIG. 1;

FIG. 6 is a bottom perspective view of the headset of FIG. 1;

FIG. 7 is a top perspective view of the headset of FIG. 1;

FIGS. 8 and 9 show the effect of swiveling the dialpad of the headset of FIG. 1;

FIG. 10 is a right side front perspective view of the headset of FIG. 1 showing in phantom a telephone base supporting said cordless telephone headset therein;

FIG. 11 is a right side front perspective view of a base for a cordless telephone headset according to this invention;

FIG. 12 is a top plan view of the base of FIG. 11;

FIG. 13 is a front elevation view of the base of FIG. 11;

FIG.. 14 is a right side elevation view of the base of FIG. 11;

FIG. 15 is a left side elevation view of the base of FIG. 11;

FIG. 16 is a rear elevation view of the base of FIG. 11;

FIG. 17 is a right side front perspective view of the base of FIG. 11 showing in phantom is a telephone headset resting therein;

FIG. 18 is a schematic diagram showing the connection between the cordless telephone headset, the base unit, and a computer; and

FIG. 19 is an illustration of a person using the cordless telephone headset, swiveling the dialpad in order to hold the phone adjacent to the user (with the phone not worn on the user's head).

### DETAILED DESCRIPTION OF THE INVENTION

With the above summary of the invention in mind, it will be helpful in more fully understanding the inventive features of the present invention to provide a thorough and detailed description of a number of specific embodiments of the invention. The following discussion emphasizes the features of the invention that provide cordless telephone headsets, systems, and features thereof. Furthermore, the following discussion emphasizes features of the invention that provide methods of the present invention, such as a method of configuring a cordless telephone headset system for use and the steps thereof. As should be understood, the present invention includes a variety of aspects that may be used in various combinations. The invention is accordingly intended to encompass a variety of embodiments of cordless telephone headset systems and combinations thereof. It may involve both methods and devices to accomplish the various aspects explained in the present discussion.

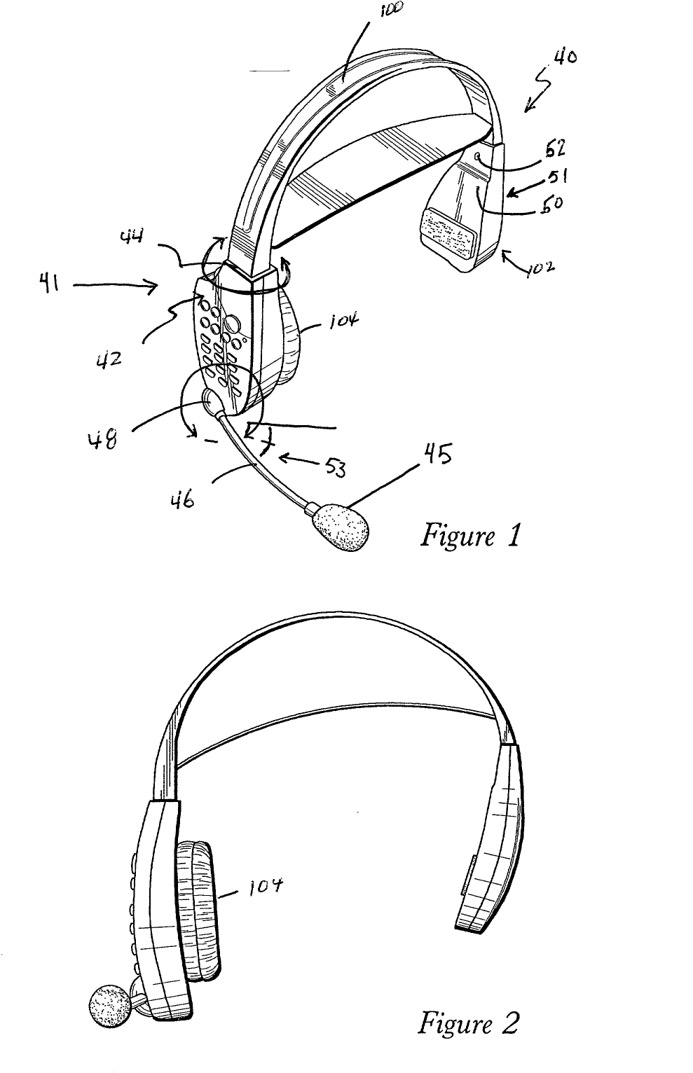

Accordingly, embodiments of the present invention are directed to a cordless telephone headset and system. Some embodiments may provide a preferably lightweight, in some embodiments under 7 ounces with batteries, wireless telephone headset 40, as shown in FIG. 1, operating as a system in conjunction with a base unit 80, as provided, for example, in FIG. 11. The cordless feature provides the ability to use the headset 40 remotely from the base 80. The telephone feature provides circuitry to accomplish telephone clarity and other functionality comparable to that of a corded phone. The cordless feature of headset 40 provides freedom of movement for hands-free convenience while a user is on the phone. The embodiments of the present invention provide a system having two general parts, a headset 40 and a base 80. The headset 40 allows a user to make or receive calls away from the base 80. The headset 40 allows the user to keep their hands free, permitting the user to do other things while talking.

Features of the present invention may be provided in various embodiments, and in various combinations, and reference is made to the appropriate figure. In reference to FIG. 1, a telephone control 41, provide in preferred embodiments as dial pad 42, is pivotally connected to one distal end of headband 100 and which adjustably rotates around point 44. Other motion may be provided, such as swivel, ratchet, among others, and should also be considered disclosed as features of the present invention. A microphone 45, and a microphone boom 46, may be provided as part of headset 40, which is pivotally connected to the telephone control and which adjustably rotates around point 48. Again, other motion may be provided, such as swivel, ratchet, among others, and should also be considered disclosed as features of the present invention. One embodiment of the invention may provide a ratchet pivot providing pivotal connection for the microphone and microphone boom to telephone control 41. Connection provided by points 44 and 48 ensure adjustable and pivotal connection of the telephone control 41 and microphone 45, and in preferred embodiments dial pad 42 and microphone boom 46, respectively, to a distal end of the headband or the telephone control or dial pad, respective of the microphone and microphone boom.

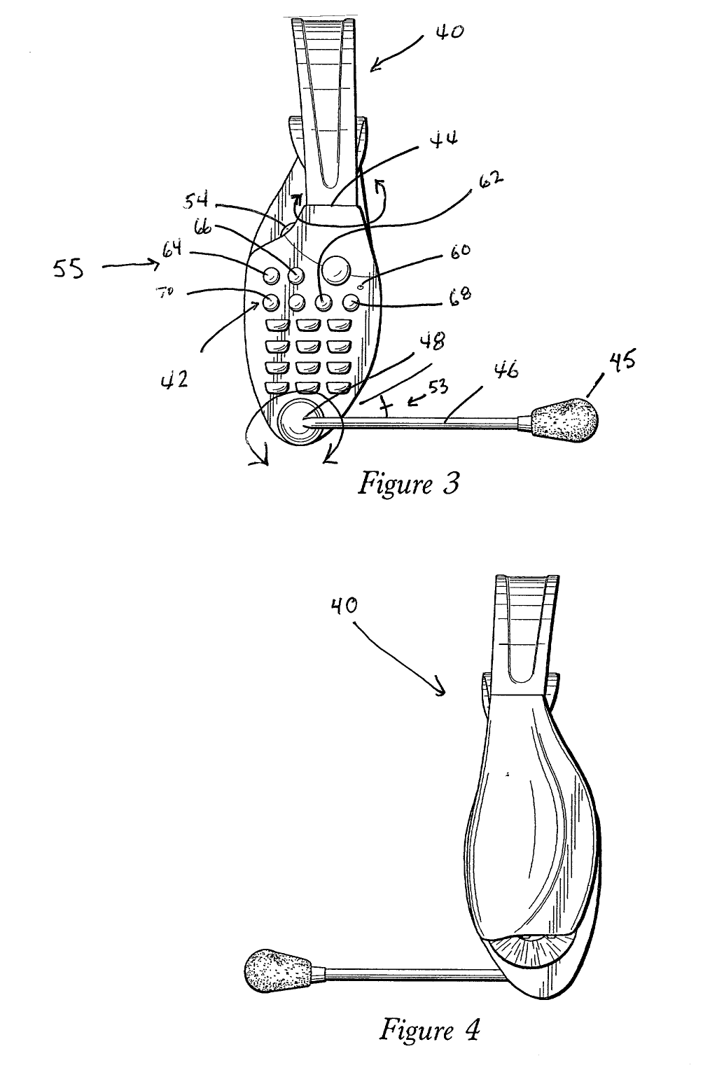

An upright orientation of the headset 40 within the base 80, as shown in FIGS. 10 and 17 provides a footprint of the base corresponding to the upright orientation of the headset, or specifically the headband and telephone control, providing a desirable resting configuration for the headset 40. The space-saving upright seating of the headset within the base makes it useful in areas where space is limited and allows for easy call pick up. A secured battery door 50 in the headset 40, fixedly connected to the headset by screw 52 may be provided to appropriately position a power source 51, preferably a battery, and as shown in FIG. 1, positioned adjacent a distal end of the headband. A rotary volume control 54, as shown, for example, in FIG. 3, may be one several or a plurality of input elements positionally associated with dial pad 42, and with the headset.

One feature of the present invention, provided in embodiments thereof, is microphone boom 46 comprising a mute switch. The mute switch is provided and activated as the boom 46 is adjusted, and in some embodiments adjustably rotating the boom, as represented as the rotational arrows about point 48 in FIG. 1, to a mute rotation angle 53, as shown in FIGS. 1 and 3. The boom may be adjusted up and away from the user's mouth such that the mute switch may be responsive to the boom at the mute rotation angle.

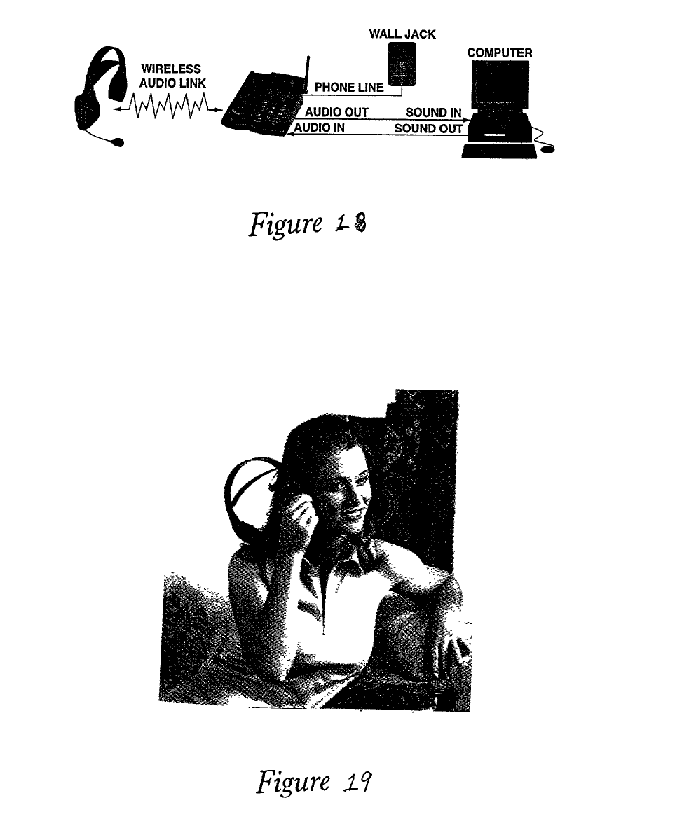

The ability to connect to a computer for computer compatibility, providing internet and computer telephony function, for example, and applications such as phone conversations and dictation conducted via a networked computer, may be provided in embodiments of the present invention. A networked computer is shown schematically in FIG. 18 in conjunction with an embodiment of the present invention, as would be understood by those skilled in the computer and telephone fields. Telephone jacks 81, such as PC/fax data jacks, as shown in FIG. 16, may be provided to facilitate computer capability.

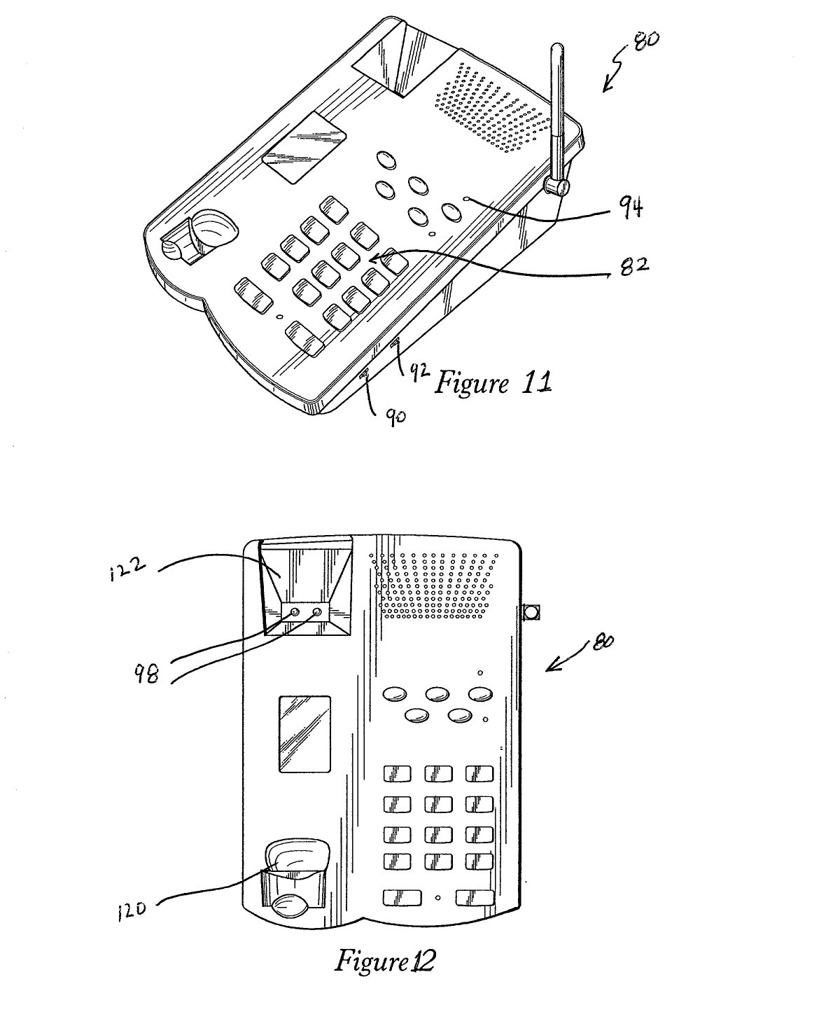

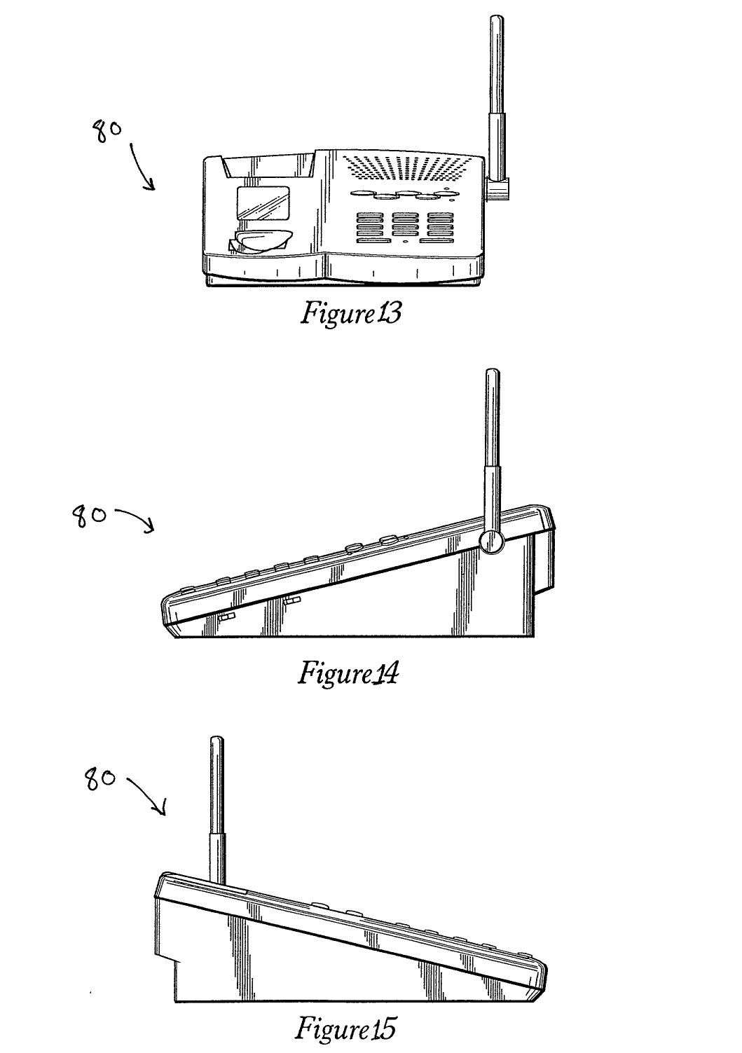

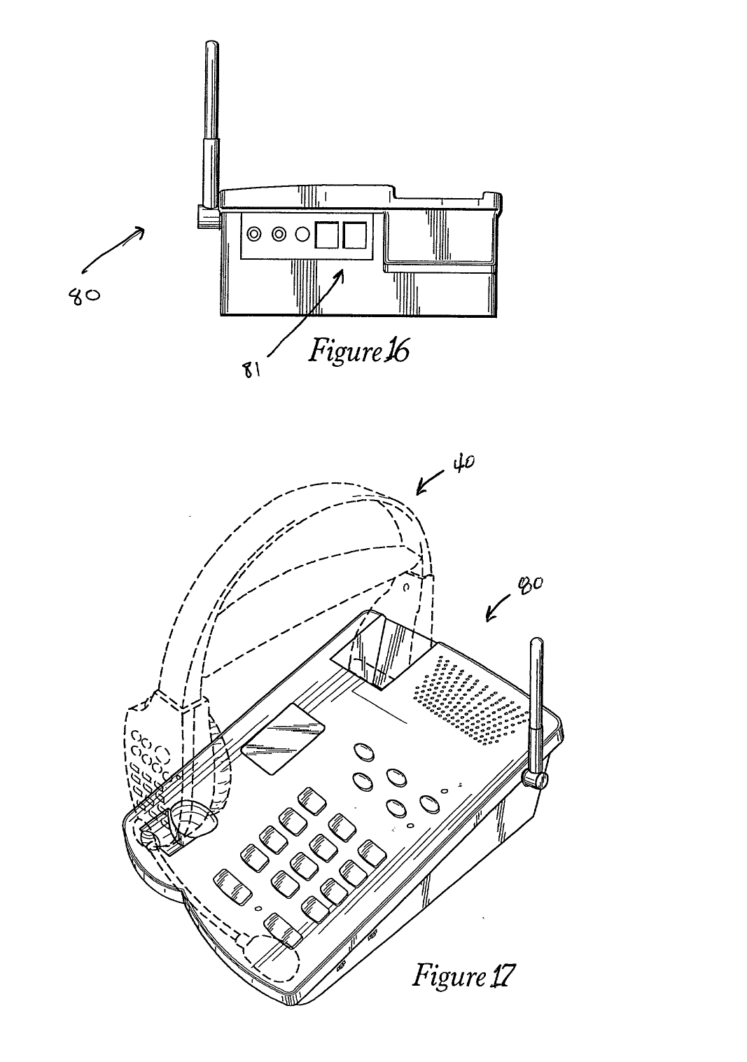

As shown in FIG. 11, it may be understood that the base unit 80 of the instant invention may include features such as: a dial pad 82 on the base 80; electronic volume control; fifty channel auto-scan; in excess of 65,000 random security codes; tone/pulse dialing 90; PC/fax data jack; ringer on/off control 92; in use/charge indicator 94; last number redial; ten-number speed dial memory; intercom/page; pause button; flash button; and computer compatibility as previously described, having sufficient compatibility with external elements such as computer sound cards and audio interfaces to enable, for example, telephone conversations to occur by way of a computer-to-computer networked connection. Charge terminals 98 of the base 80 (with reference to FIG. 12) provide for charging or recharging of the power source, preferably a battery, in the headset 40 and are correspondingly configured to the portion of the distal end of the headband.

The headset 40 of the instant invention may be configured such that the headset is comparably lightweight with regard to previous headsets of comparable design and functionality, and in some embodiments may weigh less than 7 ounces. The headset may include other features of the present invention, including a plurality of input elements positionally associated with the dial pad 42, as previously mentioned, including features and input elements such as a 10-number speed dial memory; 5 hours talk time and 7-day standby time for the battery; channel auto scan; in excess of 65,000 random security codes; in use/low battery indicator 60, shown in FIG. 3; redial/pause button 62; intercom/page 64; mute button 66; flash button 68; channel scan 70; receiver rotary volume control 54; auto talk, auto hang up; among others. It should be understood that telephone control 41 may include other control elements and features, dial pad 42 providing one preferred embodiment of telephone control 41, which should be understood to be disclosed as part of the present invention, providing other features apart from a dial pad.

An additional aspect and feature of the present invention is the adjustable connection provided by point 44, providing 180 degree of rotation of the telephone control, and in preferred embodiments dial pad 42, around point 44. While rotation within 180 degrees is preferred, a wider range all the way through 270 degrees could be provided, or even within 360 degrees of rotation. The point 44 allows for full range of motion for the dial pad 42, and allows the dial pad to be seated over the left or right ear. Further, as is seen with reference to FIGS. 8, 9 and 19, the point 44 allows for the telephone control, and in preferred embodiments dial pad 42, to be pivotally rotated, and in some embodiments, swung out and away from the headband 100 and the opposite end 102 of the headset. It being understood that the earpiece 104 is provide adjacent a second distal end of the headband, the first distal end associated with dial pad 42, on the back side of the dial pad 42, thereby providing the dial pad transversely adjacent the earpiece. One advantage is that a user may readily pick up and use the telephone headset, in a hand-held configuration for the headset as shown in FIG. 19, adjustably rotating the dial pad so that the user can put the earpiece 104 adjacent the user's ear, without having to place the headset 40 on the user's head.

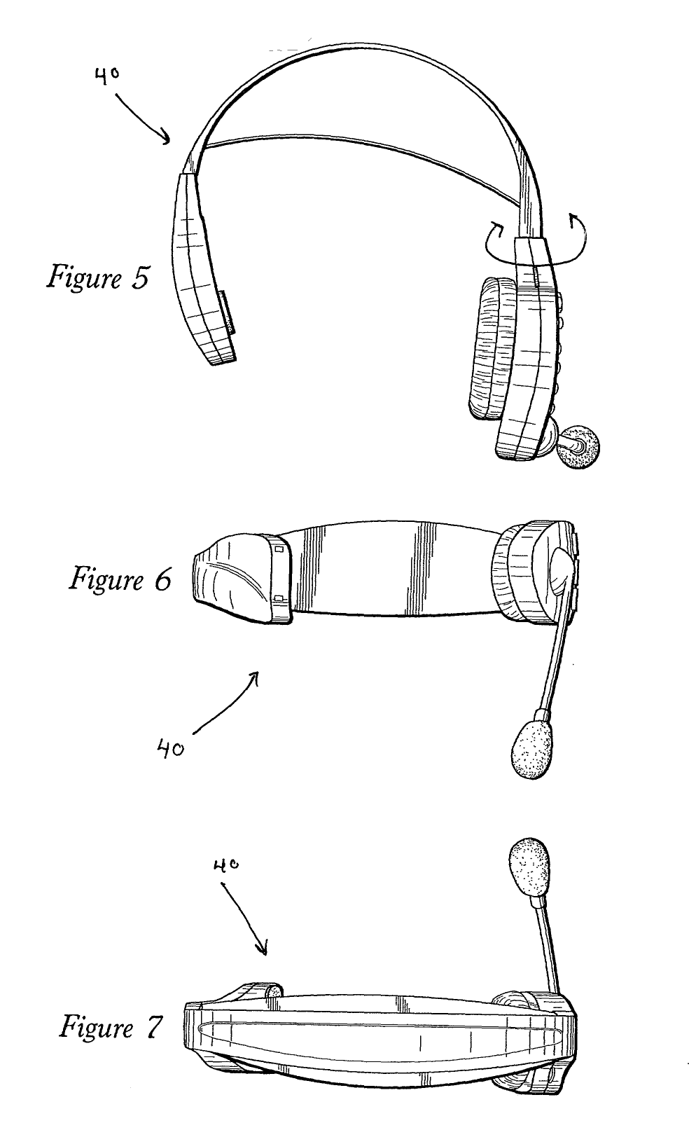

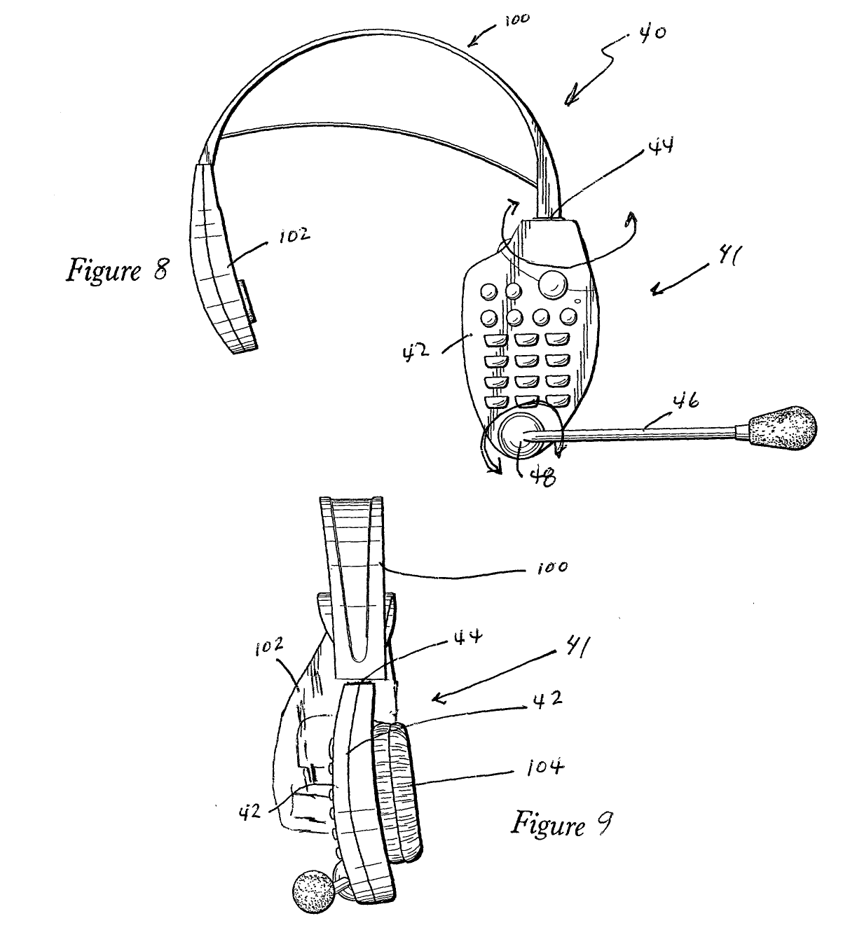

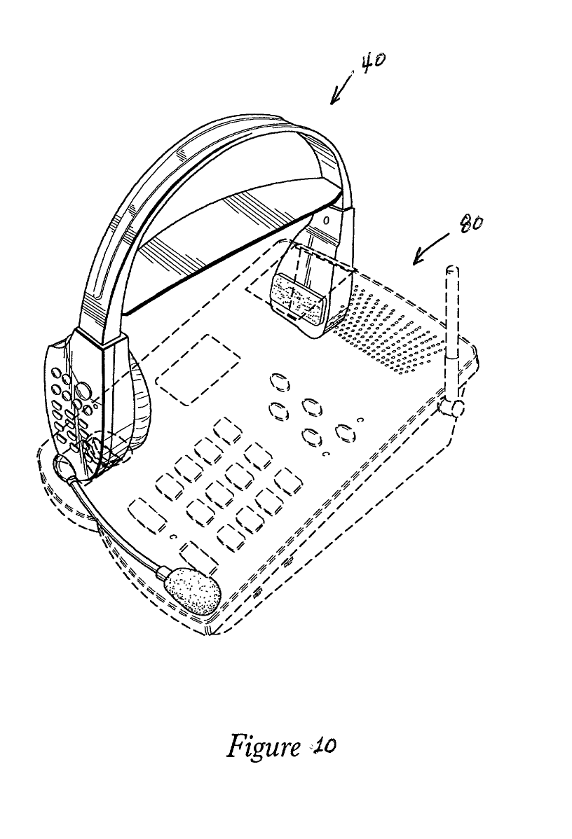

The adjustability of the present invention is enhanced by the configuration provided the telephone control or dial pad. Through the adjustable connection and pivotal configuration of the telephone control, the telephone control may be configured to accommodate a plurality of user configurations, given the possible degree of rotation, as previously described. FIGS. 8 and 9 provide one user configuration, wherein the telephone control, and in preferred embodiments dial pad 42, is rotated 90 degrees. In preferred embodiments, dial pad 42 may be adjustably connected to the headband such that adjustment may be made throughout the 180 degrees of rotation. In the embodiment shown in FIGS. 8 and 9, the telephone control 41 is configured to accommodate a right ear configuration. Adjustment of the microphone boom may further facilitate achieving a desired telephone control configuration, as further described below. A plurality of user configurations, including the hand-held configuration previously described, may be provided the telephone control given a particular range of rotation. Furthermore, and with reference to FIGS. 1-7 and FIGS. 8 and 9, rotation of the telephone control may be provided from a zero degree rotation to at least 90 degrees, such rotation allowing, in some embodiments, a hand-held configuration of the headset. Of course, one user configuration may be achieved with zero degrees of rotation of the telephone control, as shown in Figures 1-7. This configuration of the headset would likely be worn over the head of the user and is provided by the adjustable connection of the telephone control to the headband, such that the telephone control is in an aligned configuration with the headband. Adjusting the telephone control would result in rotation and an offset configuration of the telephone control with the headband. As previously mentioned, rotation of the telephone control, in preferred embodiments may be accomplished in a clockwise and counter-clockwise manner such that the telephone control may accommodate left and right ear configurations.

The adjustability of the present invention is also enhanced by the configuration provided the microphone and microphone boom. The rotational movement, and in some embodiments swivel or ratcheting movement, of the microphone boom 46 about point 48 adds a number of additional benefits. The pivotal connection provided at point 48 allows for adjustable connection of the boom to the phone control such that rotation of the boom may be achieved. The adjustable connection may be provided to allow a range of boom rotation, and in preferred embodiments, may be adjustably connected to provide 270 degrees of rotation, or in some embodiments, 360 degrees of rotation. Pivotal and adjustable connection provides, in preferred embodiments, for a plurality of user configurations, independent or in combination with adjustment of the telephone control, as previously described. The microphone boom may be adjustably connected and rotated about point 48, with the telephone control in an aligned configuration with the headband, as shown in FIG. 3. The headset may then provide a left or right ear configuration based upon the configuration of the boom. One embodiment may provide adjustment of the microphone boom from an initial or zero degree rotation to 135 degrees of rotation or more, enhancing adjustment of the boom to accommodate a user configuration, such as adjustment of the boom and placement of the telephone control and earpiece over a particular ear.

Cooperating with the dialpad 42, the earpiece 104 may be worn over either the left or right ear, accommodating a user left or right ear configuration, for users who desire to wear the headset in either left or right earpiece orientation. With both the dialpad/earpiece 42/104, in some embodiments having 180 degree rotation, and the boom arm 46, in some embodiments having 270 degree rotation, rotating in a full range of motion, the headset 40 has great flexibility. A ratcheting pivot movement of the boom arm 46 enhances precision in placement of the microphone boom 46 to provide, for example, optimal vocal pick up.

As a system, the headset 40 stands upright in the base 80 (reference FIG. 10), in a conforming first receptacle 120 (reference FIG. 12) to receive the dialpad 42 of the headset 40, and a conforming second receptacle 122 to receive the other end 102 of the headset 40 for easy placement. The upright orientation permits the user easily to pick up the headset 40 and minimizes the footprint of the base 80 to take up less space. The design of the system places the heavier telephone circuitry in the base unit 80, providing at least a portion of the telephone circuitry as telephonic control circuitry of the telephone control 41, allowing for a reduced weight of the headset 40, while retaining full features in the headset through telephone control 41, such as those described above, as well as a number of other features and advantages, which may be understood from the foregoing description and Figures. Throughout this description, a preferred rotation of 180 degrees (for telephone control, and in preferred embodiments, the dial pad/earpiece) and 270 degrees (for the microphone and microphone boom arm) have been given. Although these are preferred ranges of motion, the invention is not limited to those ranges, and the ranges could be greater or less, and may reach 360 degrees.

Since these and numerous other modifications and combinations of the above-described method and embodiments will readily occur to those skilled in the art, it is not desired to limit the invention to the exact construction and process shown and described above. For example, various other input elements may be provided in conjunction with the telephone control and in accordance with the invention disclosed. Accordingly, resort may be made to all suitable modifications and equivalents that fall within the scope of the invention as defined by the claims which follow. The words “comprise,” “comprises,” “comprising,” “include,” “including,” and “includes”, when used in this specification and in the following claims, are intended to specify the presence of stated features or steps, but they do not preclude the presence or addition of one or more other features, steps, or groups thereof. Unless denoted otherwise, the word “about” when used in relation to amounts or ranges should be construed as providing definite specificity of the present invention to the recited and/or described range of amount or activity, as may be construed by one skilled in the relevant fields of the present invention.

The embodiments of the invention presently claimed are:

1. A cordless telephone headset system, comprising:
a. a headband having two distal ends;
b. a telephone control pivotally connected to one of said distal ends of said headband; and
c. a microphone pivotally connected to said telephone control.

2. A cordless telephone headset system as described in claim 1, wherein said telephone control comprises a dial pad.

3. A cordless telephone headset system as described in claim 1, wherein said telephone control is adjustably connected to said one of said distal ends within about 180 degrees of rotation of said telephone control.

4. A cordless telephone headset system as described in claim 1, wherein said telephone control is adjustably connected to said one of said distal ends within 360 degrees of rotation of said telephone control.

5. A cordless telephone headset system as described in claim 1, further comprising an earpiece adjacent said one of said distal ends of said headband.

6. A cordless telephone headset system as described in claim 2, further comprising an earpiece adjacent said one of said distal ends of said headband, wherein said dial pad is transversely adjacent said earpiece.

7. A cordless telephone headset system as described in claim 1, further comprising a microphone one boom having two distal ends, wherein said microphone is positioned adjacent one of said distal ends of said boom, and wherein a second distal end of said microphone boom is pivotally connected to said phone control.

8. A cordless telephone headset system as described in claim 7, further comprising a ratchet pivot providing pivotal connection between said microphone boom and said phone control.

9. A cordless telephone headset system as described in claim 7, wherein said microphone boom is adjustably connected to said phone control within about 270 degrees of rotation of said microphone boom.

10. A cordless telephone headset system as described in claim 7, wherein said microphone boom is adjustably connected to said phone control within 360 degrees of rotation of said microphone boom.

11. A cordless telephone headset system as described in claim 7, wherein said microphone boom is configured to accommodate a plurality of user configurations.

12. A cordless telephone headset system as described in claim 7, wherein said microphone boom is configured to accommodate both a user left ear configuration and a user right ear configuration.

13. A cordless telephone headset system as described in claims 11 or 12, wherein said microphone boom is pivotally configured to accommodate a user configuration within a corresponding microphone boom rotation of zero to at least 135 degrees.

14. A cordless telephone headset system as described in claims 11 or 12, wherein said telephone control is configured to accommodate a plurality of user configurations.

15. A cordless telephone headset system as described in claim 12, wherein said telephone control is configured to accommodate both a user left ear configuration and a user right ear configuration.

16. A cordless telephone headset system as described in claim 12, wherein said telephone control is configured to provide a hand-held configuration of said cordless telephone headset system.

17. A cordless telephone headset system as described in claim 7, wherein said microphone boom comprises a mute switch.

18. A cordless telephone headset system as described in claim 17, wherein said microphone boom is adjustably connected to said telephone control to accommodate a mute rotation angle and wherein said mute switch is responsive to said microphone boom at said mute rotation angle.

19. A cordless telephone headset system as described in claim 2, further comprising a plurality of input elements positionally associated with said dial pad.

20. A cordless telephone headset system as described in claim 1, wherein said telephone control is configured to accommodate a plurality of user configurations.

21. A cordless telephone headset system as described in claim 1, wherein said telephone control is configured to accommodate both a user left ear configuration and a user right ear configuration.

22. A cordless telephone headset system as described in claim 1, wherein said telephone control is configured to provide a hand-held configuration of said cordless telephone headset system.

23. A cordless telephone headset system as described in claims 20, 21 or 22, wherein said telephone control is pivotally configured to accommodate a user configuration within a corresponding telephone control rotation of zero to at least 90 degrees.

24. A cordless telephone headset system as described in claim 1, wherein said telephone control is adjustably connected to said one of said distal ends to accommodate an aligned configuration of said telephone control with said headband and a plurality of offset configurations of said telephone control with said headband.

25. A cordless telephone headset system as described in claim 1, further comprising a power source positioned adjacent a second distal end of said headband.

26. A cordless telephone headset system as described in claim 25, wherein said power source comprises a battery fixedly connected to said second distal end of said headband.

27. A cordless telephone headset system as described in claim 1, further comprising a base correspondingly configured to at least a portion of said telephone control and at least a portion of a second distal end of said headband.

28. A cordless telephone headset system as described in claim 27, wherein said base is correspondingly configured to a substantially upright orientation of said headband and said telephone control.

29. A cordless telephone headset system as described in claim 28, wherein said base comprises a footprint corresponding to said substantially upright orientation.

30. A cordless telephone headset system as described in claim 27, wherein said base comprises a first receptacle corresponding to said at least a portion of said telephone control and a second receptacle corresponding to said at least a portion of a second distal end of said headband.

31. A cordless telephone headset system as described in claim 27, wherein said base comprises at least one charge terminal correspondingly configured to at least a portion of said second distal end of said headband.

32. A cordless telephone headset system as described in claim 27, further comprising telephonic control circuitry responsive to said telephone control and said base, wherein said telephone control comprises at least a portion of said telephonic control circuitry.

33. A cordless telephone headset system as described in claim 27, wherein said base is configured for computer compatibility.

34. A cordless telephone headset system as described in claims 1, 7 or 25, wherein said cordless telephone headset system weighs less than about 7 ounces.

35. A cordless telephone headset, comprising:
a. a headband having two distal ends; and
b. a dial pad pivotally connected to one of said distal ends of said headband;
w said dial pad is configured to provide a hand-held configuration of said cordless telephone headset.

36. A cordless telephone headset as described in claim 35, wherein said dial pad is pivotally configured to accommodate a hand-held configuration of said cordless telephone headset within a corresponding dial pad rotation of zero to at least 90 degrees.

37. A method of configuring a cordless telephone headset system for use, comprising the steps of:
a. configuring a telephone control of said cordless telephone headset system to a user configuration; and
b. configuring a microphone of said cordless telephone headset system corresponding to said user configuration.

38. A method of configuring a cordless telephone headset system as described in claim 37, wherein said step of configuring said telephone control comprises pivotally configuring said telephone control.

39. A method of configuring a cordless telephone headset system as described in claim 37, wherein said step of configuring said microphone comprises pivotally configuring said microphone.

40. A method of configuring a cordless telephone headset system as described in claim 37, further comprising the step of positioning said cordless telephone headset for use corresponding to said user configuration.

41. A method of configuring a cordless telephone headset system as described in claim 37, further comprising the step of positioning said cordless telephone headset for use corresponding to said user configuration prior to said step of configuring said microphone.

42. A method of configuring a cordless telephone headset system as described in claim 38, wherein said step of pivotally configuring said telephone control comprises adjustably rotating said telephone control to a user configuration within about 180 degrees of rotation of said telephone control.

43. A method of configuring a cordless telephone headset system as described in claim 38, wherein said step of pivotally configuring said telephone control comprises adjustably rotating said telephone control to a user configuration within 360 degrees of rotation of said telephone control.

44. A method of configuring a cordless telephone headset system as described in claim 39, wherein said step of pivotally configuring said microphone comprises adjustably rotating a microphone boom of said cordless telephone headset system to a user configuration within about 270 degrees of rotation of said microphone boom.

45. A method of configuring a cordless telephone headset system as described in claim 39, wherein said step of pivotally configuring said microphone comprises adjustably rotating a microphone boom of said cordless telephone headset system to a user configuration within 360 degrees of rotation of said microphone boom.

46. A method of configuring a cordless telephone headset system as described in claim 39, wherein said step of pivotally configuring said microphone comprises adjustably ratcheting a microphone boom of said cordless telephone headset system

47. A method of configuring a cordless telephone headset system as described in claim 37, wherein said step of configuring said microphone comprises configuring a microphone boom of said cordless telephone headset system to accommodate a user ear configuration.

48. A method of configuring a cordless telephone headset system as described in claim 47, wherein said step of configuring said microphone boom comprises adjustably rotating said microphone boom to a configuration corresponding to a microphone boom rotation of zero to at least 135 degrees.

49. A method of configuring a cordless telephone headset system as described in claim 48, wherein said step of configuring said telephone control comprises configuring said telephone control to accommodate a user ear configuration.

50. A method of configuring a cordless telephone headset system as described in claim 48, wherein said step of configuring said telephone control comprises providing a hand-held configuration for said cordless telephone headset.

51. A method of configuring a cordless telephone headset system as described in claim 39, wherein said step of pivotally configuring said microphone comprises adjustably rotating a microphone boom of said cordless telephone headset system to a mute rotation angle and further comprising the step of muting a communication through said cordless telephone headset system.

52. A method of configuring a cordless telephone headset system as described in claim 37, wherein said step of configuring said telephone control comprises configuring said telephone control to accommodate a user ear configuration.

53. A method of configuring a cordless telephone headset system as described in claim 37, wherein said step of configuring said telephone control comprises providing a hand-held configuration of said cordless telephone headset.

54. A method of configuring a cordless telephone headset system as described in claims 52 or 53, wherein said step of configuring said telephone control comprises adjustably rotating said telephone control to a configuration corresponding to a telephone control rotation of zero to at least 90 degrees.

55. A method of configuring a cordless telephone headset system as described in claim 37, wherein said step of configuring said telephone control comprises aligning said telephone control with a headband of said cordless telephone headset system.

56. A method of configuring a cordless telephone headset system as described in claim 37, wherein said step of configuring said telephone control comprises adjustably rotating said telephone control to offset said telephone control with a headband of said cordless telephone headset system.

57. A method of configuring a cordless telephone headset system as described in claim 37, further comprising the steps of:
a. providing a base of said cordless telephone headset system configured to at least a portion of said telephone control and at least a portion of a distal end of a headband of said cordless telephone headset system; and
b. orienting said telephone control and said headband in a substantially upright orientation.

58. A method of configuring a cordless telephone headset system as described in claim 57, wherein said step of providing a base comprises providing a base having a footprint corresponding to said substantially upright orientation achieved in said step of orienting said telephone control and said headband..

59. A method of configuring a cordless telephone headset system as described in claim 57, further comprising the step of retaining said portion of said telephone control in a first receptacle of said base and retaining at least a portion of said distal end in a second receptacle of said base.

60. A method of configuring a cordless telephone headset system as described in claim 59, further comprising the step of charging a power source positioned adjacent a second distal end of said headband.

61. A method of configuring a cordless telephone headset system as described in claim 37, further comprising the step of providing computer capability to said cordless telephone headset system.

62. A method of configuring a cordless telephone headset system as described in claim 61, wherein said step of providing computer capability comprises enabling computer telephony capability for said telephone control and said base.

63. A method of configuring a cordless telephone headset for use, comprising the step of configuring a dial pad of said cordless telephone headset to provide a hand-held configuration of said cordless telephone headset.

64. A method of configuring a cordless telephone headset for use as described in claim 63, wherein said step of configuring said dial pad comprises adjustably rotating said dial pad to a configuration corresponding to a dial pad rotation of zero to at least 90 degrees.
